(19) United States
(12) Patent Application Publication
(10) Pub. No.: US 2014/0241303 A1
(43) Pub. Date: Aug. 28, 2014

(54) TRANSCEIVING POINT, METHOD FOR SETTING A REFERENCE SIGNAL OF A TRANSCEIVING POINT, TERMINAL, AND METHOD IN WHICH A TERMINAL TRANSMITS A REFERENCE SIGNAL

(71) Applicant: Pantech Co., Ltd., Seoul (KR)

(72) Inventors: Sungjun Yoon, Seoul (KR); Donghyun Park, Seoul (KR); Sungkwon Hong, Seoul (KR)

(73) Assignee: Pantech Co., Ltd., Seoul (KR)

(21) Appl. No.: 14/348,865

(22) PCT Filed: Sep. 28, 2012
(86) PCT No.: PCT/KR2012/007934

§ 371 Date: Mar. 31, 2014

(30) Foreign Application Priority Data
Oct. 1, 2011 (KR) 10-2011-0100396
Nov. 7, 2011 (KR) 10-2011-0115445

(51) Int. Cl. H04L 5/00

(52) U.S. Cl. CPC H04L 5/005; H04L 5/0035
USPC 370/329

(57) ABSTRACT

The present invention relates to a wireless communication system in which a terminal transmits an uplink reference signal.

### CROSS-REFERENCE TO RELATED APPLICATIONS

This application is the National Stage Entry of International Application PCT/KR2012/007934, filed on Sep. 28, 2012, and claims priority from and the benefit of Korean Patent Application Nos. 10-2011-0100396, filed on Oct. 1, 2011 and 10-2011-0115445, filed on Nov. 7, 2011, which are hereby incorporated by reference for all purposes as if fully set forth herein.

### BACKGROUND

1. Field

The present invention relates generally to a wireless communication system in which a User Equipment (UE) transmits an uplink reference signal.

2. Discussion of the Background

In a wireless communication system, a UE can transmit an uplink reference signal in order to demodulate an uplink signal or estimate an uplink channel state. A reference signal (e.g. DeModulation Reference Signal; DM-RS) used for demodulation of an uplink signal is associated with transmission of a data channel (e.g. Physical Uplink Shared Channel; PUSCH) or a control channel (e.g. Physical Uplink Control Channel; PUCCH) and is mainly used for channel measurement for demodulation.

In a wireless communication system, when an uplink reference signal transmitted by a UE within a particular cell and an uplink reference signal transmitted by a UE located at a cell boundary of an adjacent cell are allocated different sequences in the same bandwidth, the orthogonality between them may be degraded. Especially, in consideration of uplink Coordinated Multi-Point transmission and reception (CoMP), the problem of orthogonality degradation should be taken into serious consideration.

### SUMMARY

An aspect of the present invention is to provide an apparatus and a method which can improve orthogonality in transmitting an uplink reference signal to a UE located in a cell boundary or a UE performing uplink CoMP.

In accordance with an aspect of the present invention, there is provided a transmission/reception point, which includes: a parameter transmission unit to generate a parameter for generation of a second base sequence different from a first base sequence specific to a serving cell, to which a User Equipment (UE) belongs, as a base sequence for an uplink reference signal and transmit the generated parameter to the UE; and an indication information transmission unit to transmit indication information on whether to use the first base sequence or the second base sequence in order to generate the base sequence, to the UE.

In accordance with another aspect of the present invention, there is provided a method of configuring a reference signal by a transmission/reception point. The method includes: generating a parameter for generation of a second base sequence different from a first base sequence specific to a serving cell, to which a User Equipment (UE) belongs, as a base sequence for an uplink reference signal, and transmitting the generated parameter to the UE; and transmitting indication information on whether to use the first base sequence or the second base sequence in order to generate the base sequence, to the UE.

In accordance with another aspect of the present invention, there is provided a UE including: a parameter reception unit to receive a parameter for generation of a second base sequence different from a first base sequence specific to a serving cell, to which the UE belongs, as a base sequence for an uplink reference signal; an indication information reception unit to receive indication information on whether to use the first base sequence or the second base sequence in order to generate the base sequence; and a reference signal transmission unit to generate a base sequence specific to the serving cell when the indication information indicates the first base sequence, generate a base sequence based on the parameter when the indication information indicates the second base sequence, and generate and transmit a reference signal based on a generated base sequence.

In accordance with another aspect of the present invention, there is provided a method of transmitting a reference signal by a UE. The method includes: receiving a parameter for generation of a second base sequence different from a first base sequence specific to a serving cell, to which the UE belongs, as a base sequence for an uplink reference signal; receiving indication information on whether to use the first base sequence or the second base sequence in order to generate the base sequence; and generating a base sequence specific to the serving cell when the indication information indicates the first base sequence, generating a base sequence based on the parameter when the indication information indicates the second base sequence, and generating and transmitting a reference signal based on a generated base sequence.

According the present invention, it is possible to improve orthogonality in transmitting an uplink reference signal.

### BRIEF DESCRIPTION OF THE DRAWINGS

FIG. 1 illustrates a communication system to which embodiments of the present invention are applied.

FIG. 2 illustrates an example of a method for transmission of PUSCHs, DM-RSs, and SRSs in an uplink of a wireless communication system.

FIG. 3 illustrates an expanded view of DM-RSs for UE1 illustrated by the unit of subcarrier, which are illustrated by the unit of resource block in FIG. 2.

FIG. 4 illustrates an example in which a UE is located at a boundary area between cells having different cell IDs.

FIG. 5 illustrates another example in which a UE performing Coordinated Multi-Point transmission and reception (CoMP) between cells exists.

FIG. 6 illustrates another example in which a UE performing CoMP exists in a system in which a micro cell by a micro transmission/reception point is located within a macro cell by a macro transmission/reception point.

FIG. 7 illustrates a plurality of UEs in cells adjacent to each other.

FIG. 8 illustrates DM-RS resources transmitted by the UEs shown in FIG. 7.

FIG. 9 illustrates a construction of a transmission/reception point according to an embodiment.

FIG. 10 illustrates a construction of a UE according to an embodiment.

FIG. 11 is a flowchart illustrating a method of transmitting a DM-RS according to an embodiment.

FIG. 12 is a diagram illustrating a case in which DM-RSs of at least a part of UEs are not allocated to all subcarriers and a subcarrier to which a DM-RS of one UE is allocated does not coincide with a subcarrier to which a DM-RS of another UE is allocated.

### DETAILED DESCRIPTION OF THE ILLUSTRATED EMBODIMENTS

Hereinafter, exemplary embodiments of the present invention will be described with reference to the accompanying drawings. In the following description, it should be noted that the same elements are designated by the same reference numerals although they are shown in different drawings. Further, in the following description of the present invention, a detailed description of known functions and configurations incorporated herein will be omitted when it may make the subject matter of the present invention rather unclear.

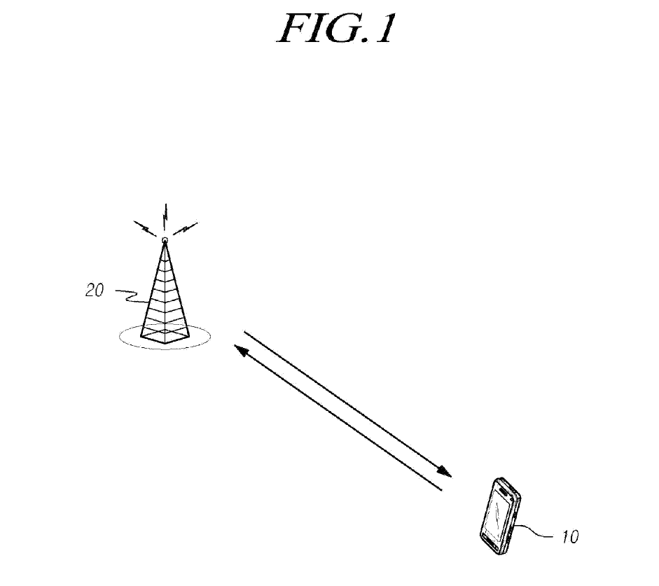

FIG. 1 illustrates a communication system to which embodiments of the present invention are applied.

A communication system is widely distributed in order to provide various communication services, such as a voice communication service or a packet data service.

Referring to FIG. 1, the wireless communication system includes a User Equipment (UE) 10 and a transmission/reception point 20 that performs uplink and downlink communication with the UE 10.

As used herein, a terminal or a UE (User Equipment) 10 has inclusive meaning referring to a user terminal in a wireless communication, and should be construed as having a concept including not only a UE in WCDMA, LTE, HSPA (High Speed Packet Access), etc. but also an MS (Mobile Station), a UT (User Terminal), SS (Subscriber Station), and a wireless device in GSM (Global System for Mobile Communication).

The BS 20 or cell generally refers to a station communicating with the UE 10, and may be called by another name, such as base station, Node-B, eNB (evolved Node-B), BTS (Base Transceiver System), AP (Access Point), or relay node.

As used herein, the transmission/reception point 20 or cell should be construed as having inclusive meaning indicating an area controlled by a BSC (Base Station Controller) of the CDMA, a Node B, etc. of the WCDMA, and is used as having an inclusive meaning implying all types of devices capable of communicating with one UE, such as RRH (Radio Remote Head) connected to a base station, relay node, sector of a macro cell, Site, a micro cell including a pico cell and a femto cell, etc.

In the present specification, the UE 10 and the transmission/reception point 20 are used as having inclusive meaning to indicate two transmitting and receiving agents used for implementation of the technology or technical idea described herein and are not limited to any specifically expressed terms or words.

Although FIG. 1 illustrates one UE 10 and one transmission/reception point 20, the present invention is not limited to the illustrated configuration. One transmission/reception point 20 can communicate with a plurality of UEs 10 or one UE 10 can communicate with a plurality of transmission/reception points 20.

There is no limit in the multiple access schemes applicable to a wireless communication system, and embodiments of the present invention can be applied to various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA.

Further, in embodiments of the present invention, the uplink transmission and the downlink transmission can employ a TDD (Time Division Duplex) scheme using different times for transmission, an FDD (Frequency Division Duplex) scheme using different frequencies for transmission, or a hybrid duplexing scheme corresponds to a combination of the TDD scheme and the FDD scheme.

Specifically, embodiments of the present invention can be applied to asynchronous wireless communication, which is evolving into the LTE (Long Term Evolution) and the LTE-Advanced (LTE-A) through the GSM, the WCDMA, and the HSPA, and synchronous wireless communication, which is evolving into CDMA, CDMA-2000, and UMB. The present invention should not be limited or restrictively construed to a particular wireless communication field, and should be construed to include all technical fields, to which the idea of the present invention can be applied.

Referring to FIG. 1, the UE 10 and the transmission/reception point 20 can perform uplink and downlink wireless communication.

In wireless communication, one radio frame is configured by 10 sub-frames and one sub-frame is configured by two slots. The radio frame has a length of 10 ms and one sub-frame may have a length of 1.0 ms. In general, the basic unit for data transmission is a sub-frame and downlink or uplink scheduling is performed for each sub-frame.

One slot includes seven symbols (in the case of normal cyclic prefix) or six symbols (in the case of extended cyclic prefix) in the time domain. In this event, a time-frequency area defined by one slot in the time domain and 12 sub-carriers corresponding to 180 kHz in the frequency domain may be referred to as a Resource Block (RB), without being limited thereto.

The transmission/reception point 20 can perform a downlink transmission to the UE 10. The transmission/reception point 20 can transmit a Physical Downlink Shared Channel (PDSCH) as a downlink data channel for unicast transmission. Further, the transmission/reception point 20 can transmit control channels, such as a Physical Downlink Control Channel (PDCCH) as a downlink control channel used for transmission of Downlink Control Information (DCI) including scheduling approval information for transmission through an uplink data channel (e.g. Physical Uplink Shared Channel (PUSCH)) and downlink control information including scheduling necessary for reception of a PDSCH, a Physical Control Format Indicator Channel (PCFICH) for transmission of an indicator distinguishing between areas of the PDCCH and the PDSCH, and a Physical HARQ Indicator Channel (PHICH) for transmission of a Hybrid Automatic Repeat request (HARQ) ACK/NACK in response to uplink transmission. In the following description, signal transmission or reception through each channel is expressed as transmission or reception of the channel itself.

The UE 10 can perform uplink transmission to the transmission/reception point 20. The UE 10 may transmit a PUSCH as an uplink data channel. Further, the UE 10 may transmit a HARQ ACK (acknowledgement)/NACK (negative ACK) indicating whether a downlink transmission block has been successfully received, a channel state report, and a Physical Uplink Control Channel (PUCCH) as an uplink control channel used for transmission of Uplink Control Information (UCI) including a scheduling request for resource allocation when uplink data is to be transmitted.

In the downlink, the transmission/reception point 20 can transmit a Cell-Specific Reference Signal (CRS), a Multicast/Broadcast over Single Frequency Network Reference Signal (MBSFN-RS), a UE-Specific Reference Signal (DM-RS), a Positioning Reference Signal (PRS), and a Channel Status Information Reference Signal (CSI-RS).

In the uplink, the UE 10 can transmit a Demodulation Reference Signal (DM-RS) and Sounding Reference Signal (SRS).

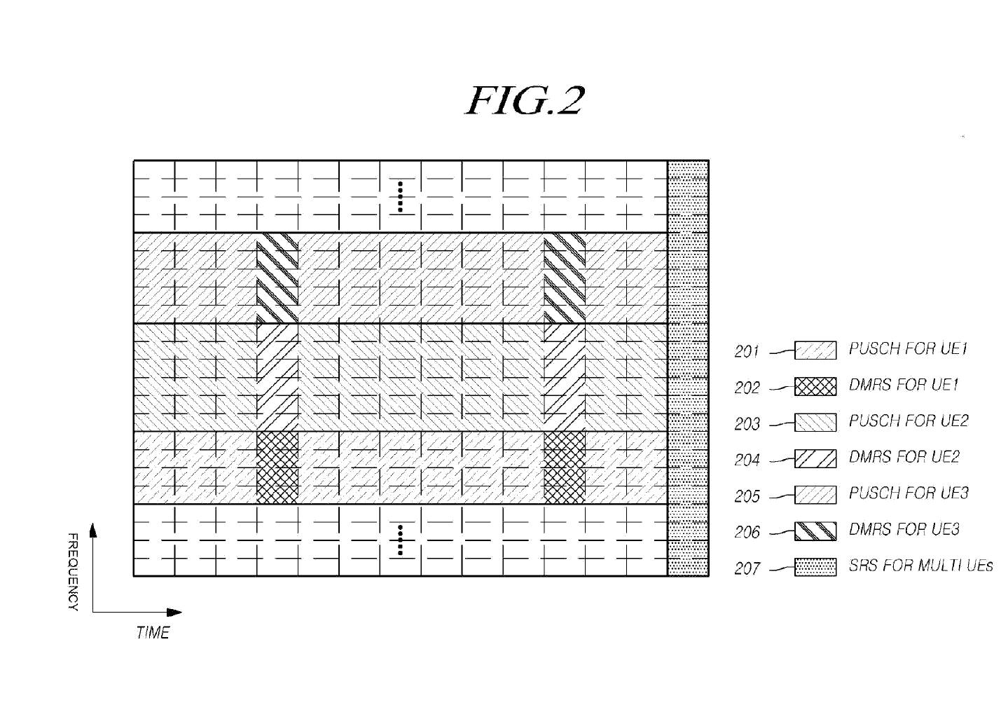

FIG. 2 illustrates an example of a method for transmission of PUSCHs, DM-RSs, and SRSs in an uplink of a wireless communication system. In FIG. 2, the transverse axis corresponds to the time axis, which indicates symbols and indicates one sub-frame in total. The longitudinal axis corresponds to the frequency axis indicating Resource Blocks (RBs).

Referring to FIG. 2, UEs (UE1 to UE3) can transmit PUSCHs 201, 203, and 205 through RBs indicated by DCIs for the UEs (UE1 to UE3), respectively. DM-RSs 202, 204, and 206, which are reference signals used in order to demodulate PUSCHs 201, 203, and 205 transmitted by the UEs (UE1 to UE3), respectively, can be transmitted in RBs, such as PUSCHs 201, 203, and 205, in the frequency axis and in one symbol of each of the two slots within the sub-frame in the time axis. SRSs 207 transmitted by UEs can be transmitted in the last symbol of the sub-frame.

The DM-RSs 202, 204, and 206 are linked with transmission of the PUSCHs 201, 203, and 205 or transmission of the PUCCHs (FIG. 2 illustrates DM-RSs linked with transmission of the PUSCHs) and are transmitted mainly for channel estimation for demodulation. In this event, the DM-RSs 202, 204, and 206 are transmitted in each slot within each sub-frame in which the PUSCHs 201, 203, and 205 or the PUCCHs are transmitted. Further, information on a BandWidth (BW) of the DM-RSs 202, 204, and 206 expressed by the unit of RB is linked with transmission of the PUSCHs 201, 203, and 205 or transmission of the PUCCHs. For example, the DM-RSs 202, 204, and 206 linked with the PUSCHs 201, 203, and 205 are transmitted in resource blocks to which the PUSCHs 201, 203, and 205 are allocated. Therefore, resource block allocation information of the DM-RSs is based on resource block allocation information of the PUSCHs. In this event, the resource blocks allocated the PUSCHs 201, 203, and 205 for UEs (UE1 to UE3), respectively, follow field values relating to resource block allocation of the Downlink Control Information (DCI).

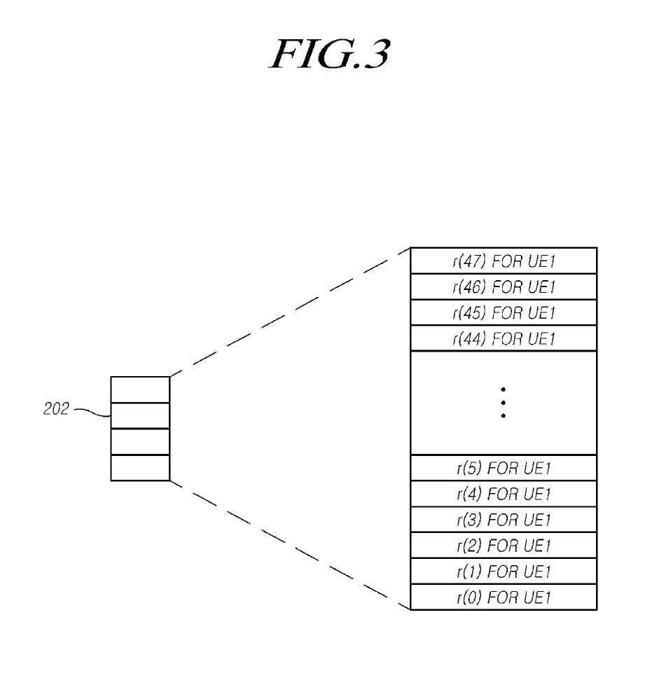

FIG. 3 illustrates an expanded view of DM-RSs 202 for UE1 illustrated by the unit of subcarrier, which are illustrated by the unit of resource block in FIG. 2. For example, in FIG. 2, the DM-RSs 202 for UE1 are transmitted through four resource blocks, and the four resource blocks are configured by a total of 48(=4*12) subcarriers r(0) to r(47) wherein each resource block includes 12 subcarriers.

Currently, a DM-RS sequence is mapped to and transmitted through all subcarriers within resource blocks used for DM-RS transmission. In this event, the DM-RS sequence can be generated by Cyclic-Shifting (CS) a base sequence based on the Zadoff-Chu sequence as noted from Equation 1 below.

r_{PUSCH}^{(λ)}(m·M_{sc}^{RS}+n)=w^{(λ)}(m)r_{u,v}^{(α}^{_{λ}}⁾(n), r_{u,v}^{(α}^{_{λ}}⁾(n)=e^{jα}^{_{λ}}ⁿ r̅_{u,v}(n), 0≦n<M_{sc}^{RS} m=0,1, n=0, . . . ,M_{sc}^{RS}−1, M_{sc}^{RC}=M_{sc}^{PUSCH} α_{λ}=2πn_{cs,λ}/12, n_{cs,λ}=(n_{DMRS}⁽¹⁾+n_{DMRS,λ}⁽²⁾+n_{PN}(nₛ))mod 12 [Equation 1]

Referring to Equation 1, the base sequence r̅_{u,v}(n) is based on a Zadoff-Chu sequence, which is a kind of CAZAC (Constant Amplitude Zero Auto-Correlation) sequence, sequence group number u and base sequence number v determine which Zadoff-Chu sequence is to be used among Zadoff-Chu sequences having the same length, and values of the sequence group number u and the base sequence number v are determined by a cell ID, a slot number, and whether to perform hopping.

More specifically, sequence group number u is calculated by Equation 2 below.

$$u = ( {f}_{gh} ( {n}_{s} ) + {f}_{ss} ) mod 30 ; \\ {f}_{gh} ( {n}_{s} ) = \{ \begin{matrix}0 & if group hopping is disabled \\ ( {\sum }_{i = 0}^{7} c ( 8 {n}_{s} + i ) \cdot {2}^{i} ) mod 30 & if group hopping is enabled\end{matrix} \\ ( \begin{matrix}Pseudo \text{-} random sequence c ( i ) \\ is initialized with {c}_{init} = ⌊ \frac{{N}_{ID}^{cell}}{30} ⌋\end{matrix} ) ; \\ {f}_{ss}^{PUCCH} = {N}_{ID}^{cell} mod 30 \\ {f}_{ss}^{PUSCH} = ( {f}_{ss}^{PUCCH} + {Δ}_{ss} ) mod 30 ( {Δ}_{ss} ∈ \{ 0 , 1 , … , 29 \} ) \qquad [ Equation 2 ]$$

As noted from Equation 2, the sequence group number u has a value obtained by adding group hopping pattern fgh(ns) and sequence-shift pattern fss and then performing a modulo (modular) 30 operation on the sum, and may have a value among 30 values from 0 to 29. The group hopping pattern fgh(ns) has a value of 0 when the group hopping is disabled, and has a value determined by the cell ID N_{ID}^{cell} and the slot number ns when the group hopping is enabled. The sequence-shift pattern fss is separately defined in a DM-RS for a PUCCH and in a DM-RS for a PUSCH and has a value, which is determined according to the cell ID N_{ID}^{cell} in the case of a DM-RS for a PUCCH and according to Δss, which is a value equally signaled to all UEs within a cell from a higher layer, and the cell ID N_{ID}^{cell} in the case of a DM-RS for a PUSCH. Δss serves as an offset in calculating the value of u. In result, the value of the sequence group number u is determined by the cell ID N_{ID}^{cell} and Δss.

Further, the base sequence number v is calculated by Equation 3 below.

$$v = \{ \begin{matrix}c ( {n}_{s} ) & \begin{matrix}if group hopping is diabled and \\ sequence hopping is enabled\end{matrix} \\ 0 & otherwise\end{matrix} \qquad [ Equation 3 ]$$

(Pseudo-random sequence c(i) is initialized with

$${c}_{init} = ⌊ \frac{{N}_{ID}^{cell}}{30} ⌋ \cdot {2}^{5} + {f}_{ss}^{PUSCH} )$$

As noted from Equation 3, the base sequence number v has a value determined by the cell ID N_{ID}^{cell}, the slot number ns, and the value of fₛₛ^{PUSCH} described above with reference to Equation 2 only in a case where the group hopping is disabled and the sequence hopping is enabled, and has a value of 0 in the other cases. Since the value of fₛₛ^{PUSCH} is determined by the cell ID N_{ID}^{cell} and Δss, the base sequence number v is determined by the cell ID N_{ID}^{cell}, the slot number ns, and Δss.

Since the base sequence r̅_{u,v}(n) is determined by the sequence group number u and the base sequence number v and the sequence group number u and the base sequence number v are determined by the cell ID N_{ID}^{cell}, the slot number ns, and Δss, the base sequence r̅_{u,v}(n) is determined by the cell ID N_{ID}^{cell}, the slot number ns, and Δss. Within one cell, the cell ID N_{ID}^{cell} is the same and the same value is transferred as Δss to all UEs. Therefore, the base sequences r̅_{u,v}(n) transmitted at an identical time (in the same slot with the same slot number ns) to all UEs within the cell have the same value. Meanwhile, since UEs belonging to different cells have different cell IDs N_{ID}^{cell} and different Δss, the base sequences r̅_{u,v}(n) have different values.

The base sequence r̅_{u,v}(n) is cyclic-shifted so that it is generated with a length (M_{sc}^{RS}=the number of used RBs×the number of subcarriers in each RB) corresponding to the length of resource blocks used for DM-RS transmission. Each sequence value within the sequence corresponds to each subcarrier within a resource area allocated for DM-RS transmission and is cyclic-shifted by a cyclic shift value α_{λ} with indexes from 0 to M_{sc}^{RS}−1.

n_{cs,λ} used for calculation of cyclic shift value α_{λ} in Equation 1 is calculated by dividing a sum of three parameters (including n_{DMRS}⁽¹⁾, n_{DMRS,λ}⁽²⁾, and n_{PN}(nₛ)) by 12. n(1)DMRS can be transmitted to a UE through higher layer signaling, such as Radio Resource Control (RRC). n_{DMRS,λ}⁽²⁾ can be transmitted to a UE through DCI. n_{PN}(nₛ) can be specifically determined according to a cell ID and a slot number.

A cyclic shift is generated through e^{jα}^{_{λ}}ⁿ by which the base sequence r̅_{u,v}(n) is multiplied. For example, when n_{cs,λ}=1, α_{λ}=2π/12, and a DM-RS is transmitted in one resource block (12 subcarriers) wherein n has values from 0 to 11, α_{λ}n has values of 0, 2p/12, 4p/12, 6p/12, 8p/12, 10p/12, 12p/12, 14p/12, 16p/12, 18p/12, 20p/12, and 22p/12, respectively. In this event, values of e^{jα}^{_{λ}}ⁿ are arranged with an identical interval of 2p/12)(30° in a complex plane.

In Equation 1, w^{(λ)}(m) denotes an OCC (Orthogonal Code Cover). [w^{λ}(0) w^{λ}(1)] may be [1 1] or [1 −1]. n_{DMRS,λ}⁽²⁾ and w^{(λ)}(m) described above may be determined by 3 bits in DCI for each layer as shown in Table 1 below. Further, in Equation 1 and Table 1, λ denotes a layer index.

TABLE 1

| Cyclic Shift Field in | | | | | | | | |
|---|---|---|---|---|---|---|---|---|
| uplink-related DCI | n_{DMRS,λ}⁽²⁾ | | | | [w^{λ}(0) w^{λ}(1)] | | | |
| format | λ = 0 | λ = 1 | λ = 2 | λ = 3 | λ = 0 | λ = 1 | λ = 2 | λ = 3 |
| 000 | 0 | 6 | 3 | 9 | [1 1] | [1 1 ] | [1 −1] | [1 −1] |
| 001 | 6 | 0 | 9 | 3 | [1 −1] | [1 −1] | [1 1] | [1 1] |
| 010 | 3 | 9 | 6 | 0 | [1 −1] | [1 −1] | [1 1] | [1 1] |
| 011 | 4 | 10 | 7 | 1 | [1 1] | [1 1] | [1 1] | [1 1] |
| 100 | 2 | 8 | 5 | 11 | [1 1] | [1 1] | [1 1] | [1 1] |
| 101 | 8 | 2 | 11 | 5 | [1 −1] | [1 −1] | [1 −1] | [1 −1] |
| 110 | 10 | 4 | 1 | 7 | [1 −1] | [1 −1] | [1 −1] | [1 −1] |
| 111 | 9 | 3 | 0 | 6 | [1 1] | [1 1] | [1 −1] | [1 −1] |

By the method described above, it is possible to obtain a DM-RS sequence r_{PUSCH}^{(λ)}.

In the case of n_{cs,λ} corresponding to a cyclic shift value of a DM-RS sequence defined in Equation 1, it should satisfy Equation 4 below in order to maintain the orthogonality.

n_{cs,λ}·M_{sc}^{RS}/12εZ, n_{cs,λ}ε{0,1, . . . ,11} [Equation 4]

In Equation 2, Z is an integer.

Meanwhile, when a UE located in a boundary area between a plurality of cells having different cell IDs transmits a DM-RS, an interference may occur between this DM-RS and another DM-RS transmitted from another UE.

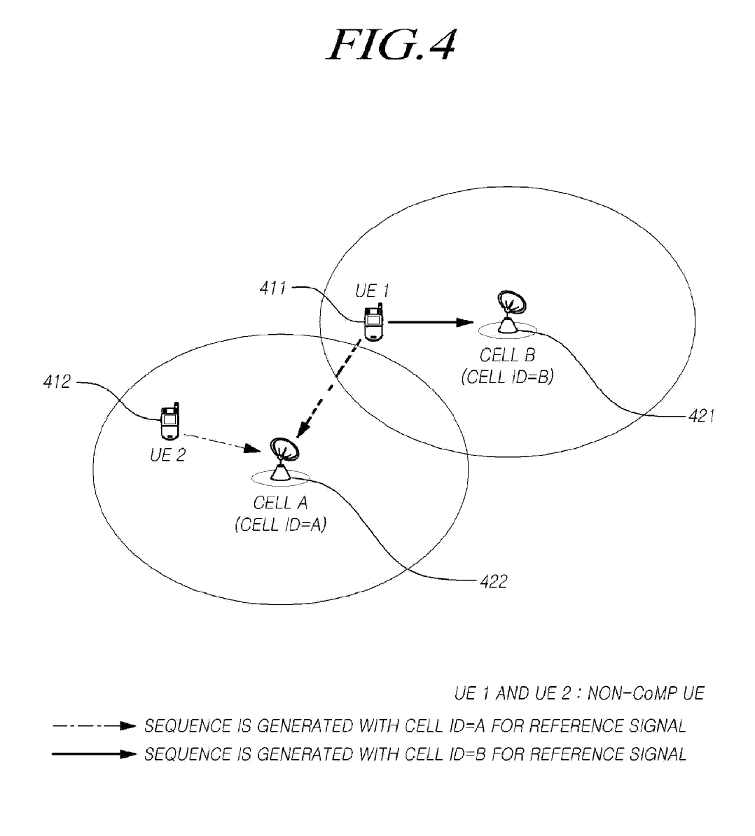

FIG. 4 illustrates an example in which a UE is located at a boundary area between cells having different cell IDs.

Referring to FIG. 4, a UE 411 uses a transmission/reception point 421 having a cell ID of B as its serving cell and a UE 412 uses a transmission/reception point 422 having a cell ID of A as its serving cell. When the UE 411 transmits a DM-RS by a DM-RS sequence calculated using the cell ID of B, since the UE 411 is located at the boundary area between the cells, the DM-RS transmitted by the UE 411 may reach the transmission/reception point 422 as well as the transmission/reception point 421. When a resource of the DM-RS transmitted by the UE 411 and a physical resource of the DM-RS transmitted by the UE 412 entirely or partially overlap each other in their positions, the DM-RS transmitted by the UE 411 may function as interference to the DM-RS transmitted by the UE 412. In order to reduce the interference by the DM-RS transmitted by the UE 411, orthogonality should be secured between the DM-RS transmitted by the UE 411 and the DM-RS transmitted by the UE 412.

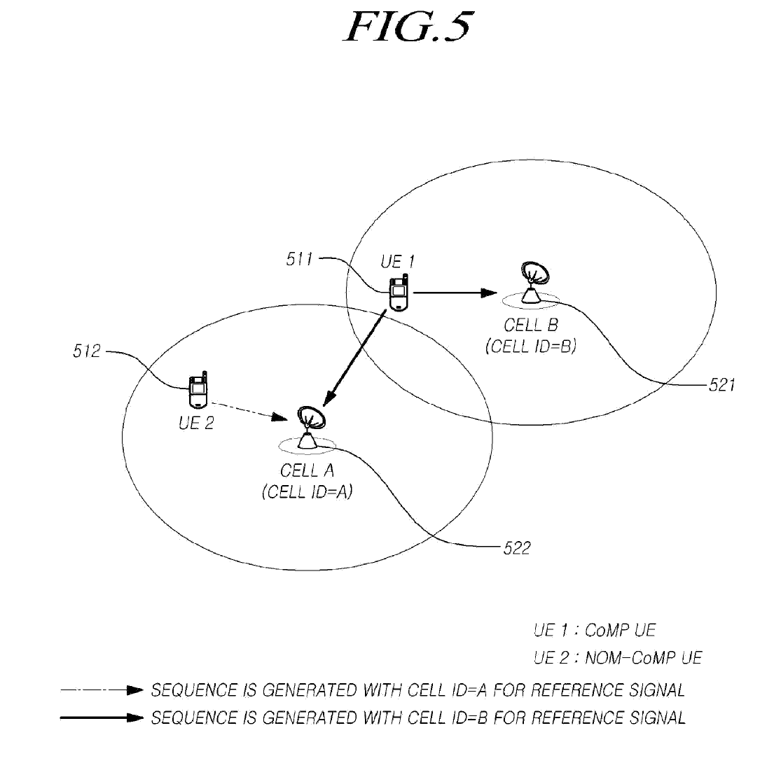

FIG. 5 illustrates another example in which a UE performing Coordinated Multi-Point transmission and reception (CoMP) between cells exists.

Referring to FIG. 5, the UE 511 corresponds to a UE performing uplink CoMP and the UE 512 corresponds to a UE that does not perform CoMP. A DM-RS transmitted by the UE 511 performing uplink CoMP is received by the transmission/reception point 521 and the transmission/reception point 522. A DM-RS sequence to be transmitted by the UE 511 is generated based on the cell ID of B. A DM-RS transmitted by the UE 512 that does not perform CoMP is received by the transmission/reception point 522. A DM-RS sequence to be transmitted by the UE 512 is generated based on the cell ID of A. In this event, the transmission/reception point 522 should receive both the DM-RS transmitted by the UE 511 performing uplink CoMP and the DM-RS transmitted by the UE 512 that does not perform CoMP. When resources of the DM-RS transmitted by the UE 511 performing uplink CoMP and the DM-RS transmitted by the UE 512 that does not perform CoMP overlap each other, the orthogonality between the DM-RSs should be secured for a distinguished reception of them.

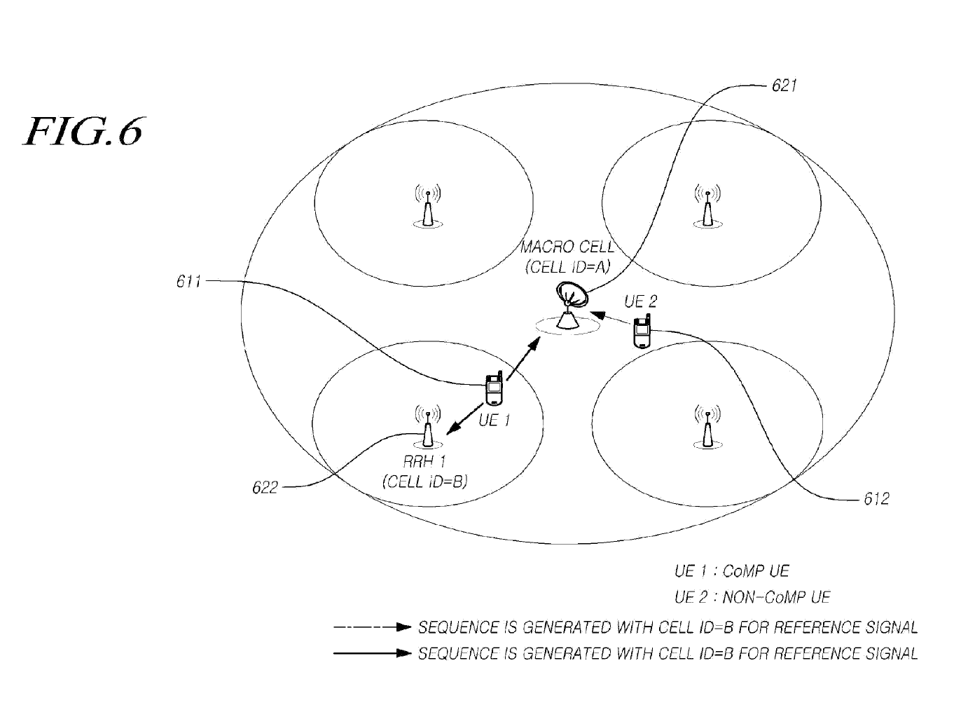

FIG. 6 illustrates another example in which a UE performing CoMP exists in a system in which a micro cell by a micro transmission/reception point 622 is located within a macro cell by a macro transmission/reception point 621.

In FIG. 6, the transmission/reception point 621 may be a macro evolved Node B (eNB) and the transmission/reception point 622 may be a micro transmission/reception point, such as an RRH, a relay node, a femto cell, or a pico cell.

Referring to FIG. 6, the UE 611 corresponds to a UE performing uplink CoMP and the UE 612 corresponds to a UE that does not perform uplink CoMP. A DM-RS transmitted by the UE 611 performing uplink CoMP is received by the macro transmission/reception point 621 and the micro transmission/reception point 622. A DM-RS sequence to be transmitted by the UE 611 is generated based on the cell ID of B. A DM-RS transmitted by the UE 612 that does not perform CoMP is received by the macro transmission/reception point 621. A DM-RS sequence to be transmitted by the UE 612 is generated based on the cell ID of A. In this event, the macro transmission/reception point 621 should receive both the DM-RS transmitted by the UE 611 performing uplink CoMP and the DM-RS transmitted by the UE 612 that does not perform CoMP. When resources of the DM-RS transmitted by the UE 611 performing CoMP and the DM-RS transmitted by the UE 612 that does not perform uplink CoMP overlap each other, the orthogonality between the DM-RSs should be secured for a distinguished reception of them.

Meanwhile, in the system of FIG. 6, the cell ID of A of the macro cell and the cell ID of B of the micro cell may be the same. In this event, DM-RS sequences to be transmitted by all the UEs 611 and 612 are generated based on the same cell ID. A DM-RS transmitted by the UE 611 performing CoMP is received by the macro transmission/reception point 621 and the micro transmission/reception point 622. A DM-RS transmitted by the UE that does not perform CoMP is received by the macro transmission/reception point 621. In this event, the macro transmission/reception point 621 should receive both the DM-RS transmitted by the UE 611 performing uplink CoMP and the DM-RS transmitted by the UE 612 that does not perform CoMP. When resources of the DM-RS transmitted by the UE 611 performing CoMP and the DM-RS transmitted by the UE 612 that does not perform uplink CoMP overlap each other, the orthogonality between the DM-RSs should be secured for a distinguished reception of them.

To this end, an embodiment of the present invention proposes a scheme for securing the orthogonality, in which DM-RS sequences of a UE 411, 511, or 611 that performs CoMP or is located at a cell boundary area in FIGS. 4 to 6 and a UE 412, 512, or 612 having overlapping DM-RS resources have the same u value and the same v value, have the same bandwidth (the number of resource blocks) to which the DM-RS sequences are allocated, and have the same start point for their allocation, so as to allow the DM-RSs to be allocated only within the same resource block. Then, the two sequences use the same base sequence r̅_{u,v}(n) and can be distinguished from each other by Cyclic Shift (CS).

In this event, the values of u and v determining the base sequence are determined by the cell ID N_{ID}^{cell}, the slot number ns, and Δss as noted from Equations 2 and 3, and Δss is commonly signaled within a cell and has the same value for all UEs within one cell although it may have different values for different cell IDs. Therefore, in generating an uplink DM-RS sequence, all UEs within a particular cell at a particular time (slot) have the same u value and the same v value. Therefore, when DM-RS sequences of a UE 411, 511, or 611 that performs CoMP or is located at a cell boundary area in FIGS. 4 to 6 and a UE 412, 512, or 612 having overlapping DM-RS resources with them have the same u value and the same v value, DM-RS sequences of all UEs within the cell to which the UE belongs also have the same u value and the same v value.

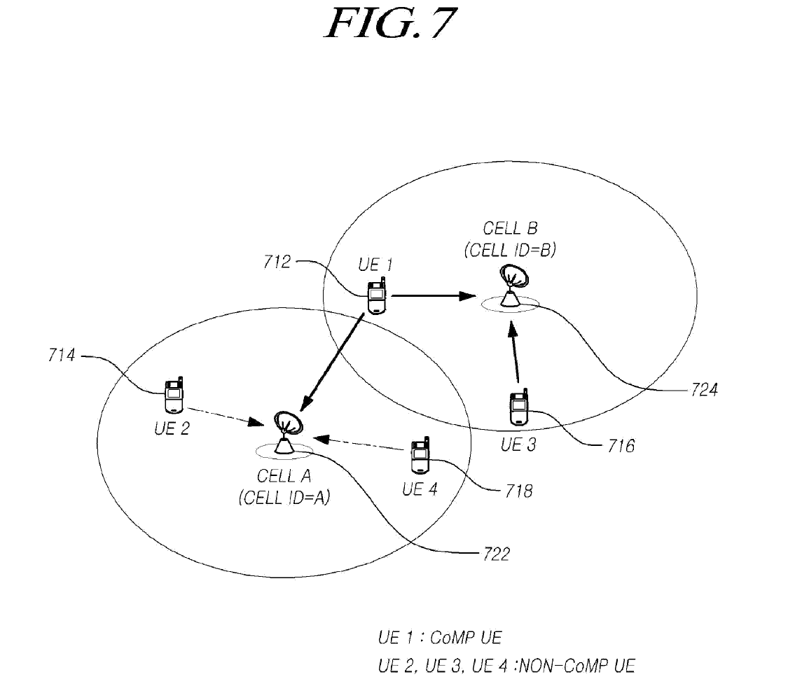

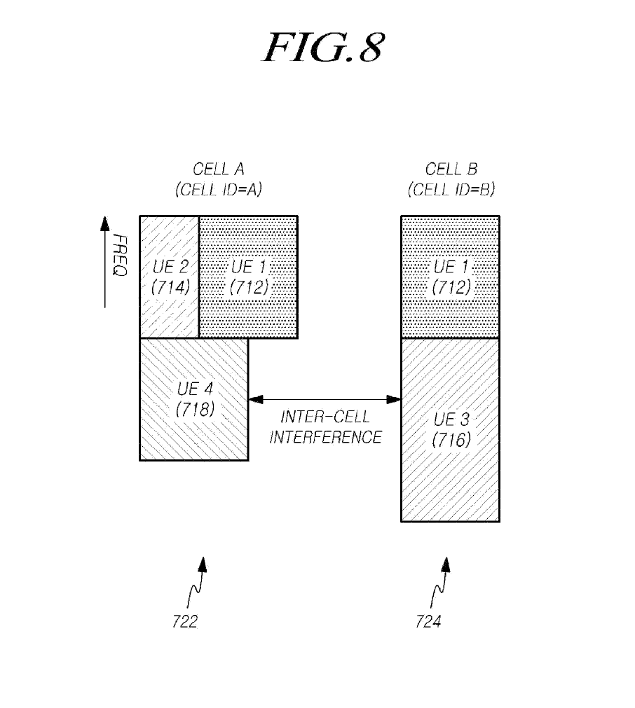

FIG. 7 illustrates a case in which a plurality of UEs are located in cells adjacent to each other, and FIG. 8 illustrates DM-RS resources transmitted by the UEs in the case shown in FIG. 7.

Referring to FIG. 7, a UE 712 is a UE which is located at a cell boundary area and performs CoMP. The UE 712 communicates with a transmission/reception point 722 having a cell ID of A and a transmission/reception point 724 having a cell ID of B. The UE 714 and the UE 718 belonging to a cell different from the cell, to which the UE 712 belongs, communicate with the transmission/reception point 722 having the cell ID of A, and the UE 716 belonging to the same cell as the cell, to which the UE 712 belongs, communicates with the transmission/reception point 724 having the cell ID of B.

Referring to FIG. 8, the transmission/reception point 722 receives DM-RSs transmitted by the UEs 712, 714, and 718 and the transmission/reception point 724 receives DM-RSs transmitted by the UEs 712 and 716. In this situation, the DM-RSs transmitted by the UE 712 and the DM-RSs transmitted by the UE 714 have overlapping frequency bands. In order to distinguish between the overlapping frequency bands, u and v of the DM-RS sequence transmitted by the UE 712 may have the same values as those of u and v of the DM-RS sequence transmitted by the UE 714. In this event, the UE 718 located in the same cell (having the cell ID of A) as that of the UE 714 also have the same u and v values of the DM-RS sequence, and the UE 716 located in the same cell (having the cell ID of b) as that of the UE 712 also have the same u and v values of the DM-RS sequence. Then, the DM-RS allocation resource of the UE 718 and the DM-RS allocation resource of the UE 716 may have different bandwidths or different start points.

When DM-RS sequences from different UEs have the same u and v values, the same resource allocation area, and are distinguished from each other by cyclic shift, the orthogonality between the DM-RSs can be secured. However, when DM-RS sequences from different UEs have different resource allocation areas even though they have the same u and v values, the orthogonality between the DM-RSs may be degraded in comparison with the orthogonality between the DM-RSs in the case where the DM-RS sequences have different u and v values and different resource allocation areas. In the example shown in FIG. 7, although the u and v values of the DM-RS sequence of the UE 716 are the same as the u and v values of the DM-RS sequence of the UE 718, the DM-RS resource allocation area of the UE 716 and the DM-RS resource allocation area of the UE 718 are different from each other. In this case, the orthogonality may be degraded in comparison with the orthogonality in the case where the DM-RS sequence of the UE 716 and the DM-RS sequence of the UE 718 have different u and v values and different resource allocation areas.

Therefore, it is advantageous in view of the orthogonality to generate DM-RS sequences by providing the same u and v values of the DM-RS sequences and the same resource allocation area to the UE 712, which is located in a cell boundary, and the UE 714, which has an overlapping uplink resource with that of the UE 712 and belongs to another cell different from that of the UE 712, and then applying different cyclic shifts to the UE 712 and the UE 714. Hereinafter, a base sequence, which is identically generated with u and v values of a common DM-RS sequence from DM-RSs of UEs belonging to different cells, will be referred to as a base sequence common in a CoMP set or, simply, as a common base sequence. In contrast, it may be advantageous in view of the orthogonality that the UE 716 and the UE 718 having different resource allocation areas have different u and v values for the DM-RS sequence. That is, it may be advantageous that the UE 716 and the UE 718 independently generate DM-RS sequences by parameters specific to cells, respectively. Hereinafter, a base sequence generated by a parameter specific to a cell will be referred to as a cell-specific base sequence.

In this event, the UE 712 and the UE 716 belonging to the same cell (cell B) may have different DM-RS base sequences (a common base sequence and a cell-specific base sequence) and/or the UE 714 and the UE 718 may have different DM-RS base sequences (a common base sequence and a cell-specific base sequence). The transmission/reception points 722 and 724 can transmit a parameter for generating a common base sequence and a parameter for generating a cell-specific base sequence to each UE to indicate which sequence between the common base sequence and the cell-specific base sequence each UE should generate and transmit a DM-RS by using the generated sequence.

Meanwhile, in the example of FIG. 7, the cell ID of A and the cell ID of B may have the same value. That is, the transmission/reception point 722 and the transmission/reception point 724 may be transmission/reception points cooperating with each other in one cell. In this event, DM-RS sequences of the UEs 712 to 718 may have the same u and v values.

Referring to FIG. 8, the transmission/reception point 722 receives DM-RSs transmitted by the UEs 712, 714, and 718 and the transmission/reception point 724 receives DM-RSs transmitted by the UEs 712 and 716. In this situation, the DM-RSs transmitted by the UE 712 and the DM-RSs transmitted by the UE 714 have overlapping frequency bands, and u and v of the DM-RS sequence transmitted by the UE 712 have the same values as those of u and v of the DM-RS sequence transmitted by the UE 714. Then, by distinguishing between the DM-RS transmitted by the UE 712 and the DM-RS transmitted by the UE 714 by cyclic shifting, the orthogonality between the DM-RSs can be secured. That is, when a plurality of transmission/reception points have the same cell ID, it may be advantageous for a plurality of UEs using different resource allocation areas to generate base sequences by using cell-specific parameters.

Meanwhile, although the u and v values of the DM-RS sequence of the UE 716 are the same as the u and v values of the DM-RS sequence of the UE 718, the DM-RS resource allocation area of the UE 716 and the DM-RS resource allocation area of the UE 718 are different from each other. In this case, the orthogonality may be degraded in comparison with the orthogonality in the case where the DM-RS sequence of the UE 716 and the DM-RS sequence of the UE 718 have different u and v values and different resource allocation areas. In this event, it may be advantageous that the UE 716 and the UE 718 independently generate DM-RS sequences by using parameters specific to the UEs (or parameters specific to the transmission/reception points receiving the DM-RSs) instead of parameters specific to cells, respectively. Hereinafter, a base sequence generated by a parameter specific to a UE (or a parameter specific to a transmission/reception point) will be referred to as a UE-specific base sequence (or a transmission/reception point-specific base sequence).

That is, in FIG. 8, the UE 712 and the UE 714 may have the same DM-RS sequence. In this event, a base sequence common in a CoMP set may be used in an environment in which transmission/reception points have different cell IDs, such as CoMP scenario 1/2/3, etc., and an existing cell-specific base sequence may be used in an environment in which transmission/reception points have the same cell ID, such as CoMP scenario 4, etc. Further, in FIG. 8, the UE 716 and the UE 718 may have different DM-RS sequences. In this event, an existing cell-specific base sequence may be used in an environment in which transmission/reception points have different cell IDs, such as CoMP scenario 1/2/3, etc., and a UE-specific base sequence (or a transmission/reception point-specific base sequence) may be used in an environment in which transmission/reception points have the same cell ID, such as CoMP scenario 4, etc.

Therefore, in order to generate other types of base sequences further to the existing cell-specific base sequence, the transmission/reception points 722 and 724 can transmit parameters for generating a UE-specific base sequence (or a transmission/reception point-specific base sequence) or a base sequence common in a CoMP set, and indicate which sequence between a first base sequence, which corresponds to the existing cell-specific base sequence, and a second base sequence, which corresponds to the UE-specific base sequence (or a transmission/reception point-specific base sequence) or the base sequence common in the CoMP set, each UE should use to generate and transmit a DM-RS, according to an environment in which the UE is placed.

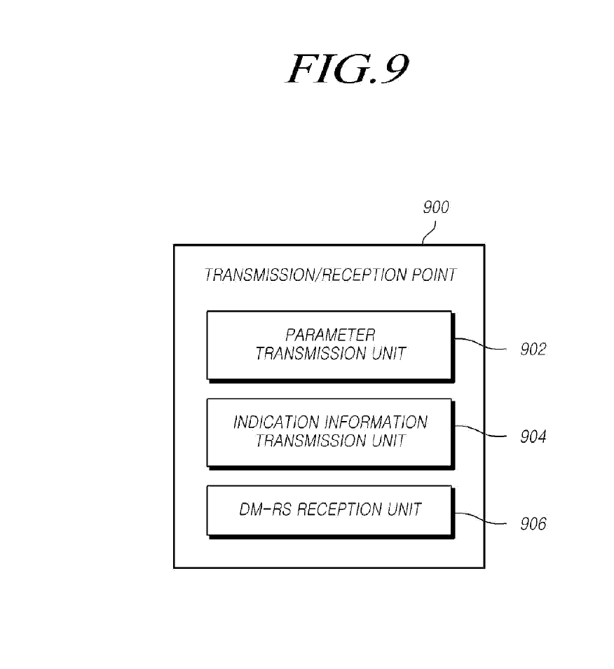

FIG. 9 illustrates a construction of a transmission/reception point according to an embodiment.

Referring to FIG. 9, a transmission/reception point 900 includes a parameter transmission unit 902 that generates and transmits a parameter for generation of a common base sequence common in a DM-RS CoMP set, an indication information transmission unit 904 that generates and transmits indication information on which sequence between a cell-specific base sequence and the common base sequence common in the DM-RS CoMP set a particular UE should use to transmit a DM-RS, and a DM-RS reception unit 906 that receives a DM-RS transmitted by a UE.

The parameter transmission unit 902 generates a parameter for generation of a UE-specific base sequence (or a transmission/reception point-specific base sequence) or a common base sequence common in a CoMP set. The parameter for generation of the UE-specific base sequence (or the transmission/reception point-specific base sequence) or the common base sequence common in the CoMP set may be u, v, cell ID, or Δss. The parameter for generation of a UE-specific base sequence (or a transmission/reception point-specific base sequence) or a common base sequence common in a DM-RS CoMP set may be transmitted through signaling of a higher layer, such as RRC.

The indication information transmission unit 904 generates indication information indicating whether each UE should generate a DM-RS by using a first base sequence corresponding to a cell-specific base sequence or generate a DM-RS by using a second base sequence corresponding to a UE-specific base sequence (or a transmission/reception point-specific base sequence) or a common base sequence common in a CoMP set. The indication information may be explicit information or implicit information. The indication information may be transmitted through a downlink control channel, such as a PDCCH. The DM-RS reception unit 906 receives a DM-RS transmitted by a UE.

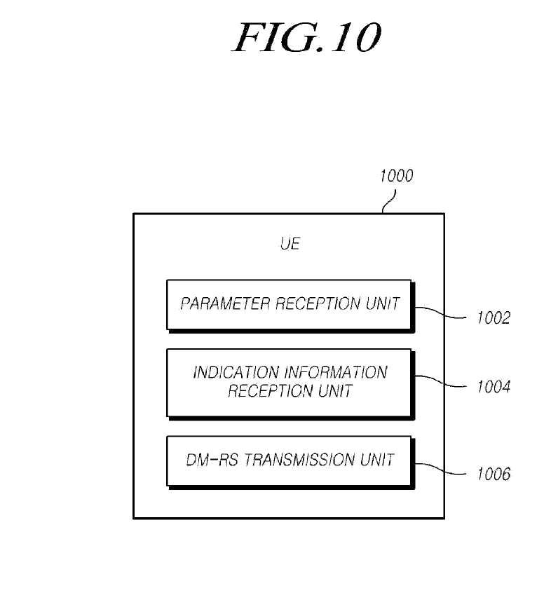

FIG. 10 illustrates a construction of a UE according to an embodiment.

Referring to FIG. 10, a UE 1000 includes a parameter reception unit 1002 that receives a parameter for generation of a base sequence common in a DM-RS CoMP set or a UE-specific base sequence (or a transmission/reception point-specific base sequence), an indication information reception unit 1004 that receives indication information on which sequence between a first base sequence, which corresponds to a cell-specific base sequence, and a second base sequence, which corresponds to a UE-specific base sequence (or a transmission/reception point-specific base sequence) or a base sequence common in the CoMP set, the UE should use to generate and transmit a DM-RS, and a DM-RS transmission unit 1006 that transmits and generates a DM-RS.

The parameter reception unit 1002 receives a parameter for generation of a UE-specific base sequence (or a transmission/reception point-specific base sequence) or a common base sequence common in a DM-RS CoMP set. The parameter for generation of the UE-specific base sequence (or the transmission/reception point-specific base sequence) or the common base sequence common in the CoMP set may be u, v, cell ID, or Δss. The parameter for generation of a UE-specific base sequence (or a transmission/reception point-specific base sequence) or a common base sequence common in a DM-RS CoMP set may be received through signaling of a higher layer, such as RRC.

The indication information reception unit 1004 receives indication information indicating whether the UE should generate and transmit a DM-RS by using a first base sequence corresponding to a cell-specific base sequence or generate and transmit a DM-RS by using a second base sequence corresponding to a UE-specific base sequence (or a transmission/reception point-specific base sequence) or a common base sequence common in a CoMP set. The indication information may be explicit information or implicit information. The indication information may be received through a downlink control channel, such as a PDCCH.

The DM-RS transmission unit 1006 generates and transmits a DM-RS. When the indication information received by the indication information reception unit 1004 indicates a cell-specific base sequence, the DM-RS transmission unit 1006 generates a base sequence of a DM-RS based on Δss specific to the cell to which the UE belongs and a cell ID of the cell to which the UE belongs, maps the DM-RS sequence to a resource element within an allocation bandwidth, and then generates and transmits the signal. When the indication information indicates a UE-specific base sequence (or a transmission/reception point-specific base sequence) or a base sequence common in a CoMP set, the DM-RS transmission unit 1006 generates a base sequence of a DM-RS based on a parameter received by the parameter reception unit 1002, maps the DM-RS sequence to a resource element within an allocation bandwidth, and then generates and transmits the signal.

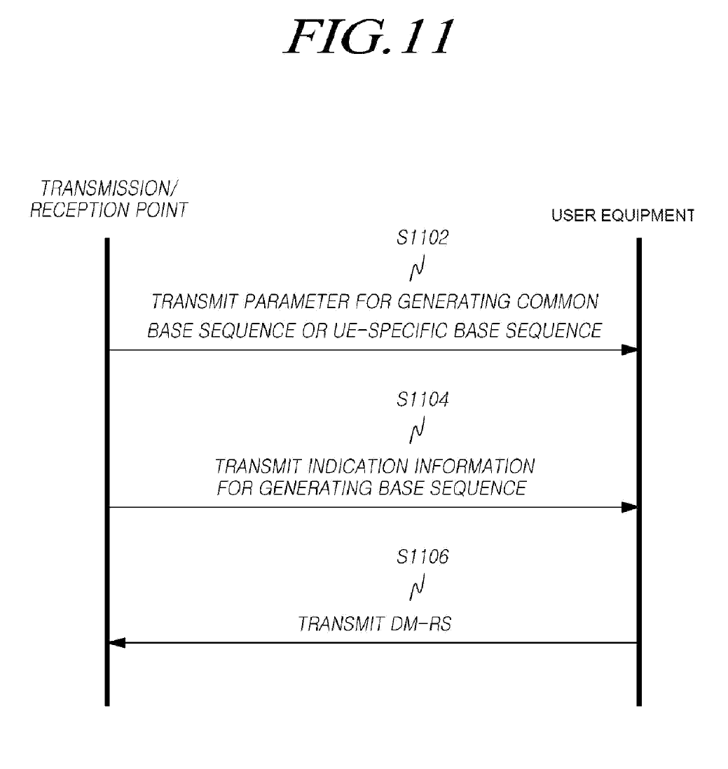

FIG. 11 is a flowchart illustrating a method of transmitting a DM-RS according to an embodiment.

Referring to FIG. 11, a transmission/reception point transmits a parameter for generation of a UE-specific base sequence (or a transmission/reception point-specific base sequence) or a base sequence common in a CoMP set to a UE (S1102). The parameter for generation of the UE-specific base sequence (or the transmission/reception point-specific base sequence) or the common base sequence common in the CoMP set may be u, v, cell ID, or Δss. The parameter for generation of a UE-specific base sequence (or a transmission/reception point-specific base sequence) or a common base sequence may be transmitted through signaling of a higher layer, such as RRC.

The transmission/reception point transmits indication information indicating whether the UE should transmit a DM-RS by generating a cell-specific base sequence or transmit a DM-RS by generating a UE-specific base sequence (or a transmission/reception point-specific base sequence) or a base sequence common in a CoMP set (S1104). The indication information may be explicit information or implicit information. The indication information may be transmitted through a downlink control channel, such as a PDCCH.

The UE generates and transmits a DM-RS (S1106). When the indication information transmitted in step S1104 indicates a cell-specific base sequence, the UE generates a base sequence of a DM-RS based on Δss specific to the cell to which the UE belongs and a cell ID of the cell to which the UE belongs, maps the DM-RS sequence to a resource element within an allocation bandwidth, and then generates and transmits the signal. When the indication information indicates a UE-specific base sequence (or a transmission/reception point-specific base sequence) or a base sequence common in a CoMP set, the UE generates a base sequence of a DM-RS based on the parameter transmitted in step S1102, maps the DM-RS sequence to a resource element within an allocation bandwidth, and then generates and transmits the signal.

In another embodiment, the parameter transmitted in step S1102 may be an ID of another cell other than an ID of a serving cell. As used herein, when a base sequence common in a CoMP set is used, the cell ID transmitted as a parameter in step S1102 is referred to as a CoMP set ID or a common ID. The CoMP set ID is an ID commonly applied to a set including a plurality of cells and has a value identically configured for the plurality of cells to which the CoMP set ID is applied.

In the example of FIG. 7, CoMP is applied to cell A and cell B and a CoMP set ID is commonly signaled to cell A and cell B. The number of signaled bits may be, but is not limited to, 9. When a base sequence common in a CoMP set is generated, a CoMP set ID may be applied, instead of a cell ID of a serving cell, to the cell ID N_{ID}^{cell} in Equations 2 and 3 for calculating u and v. Here, the CoMP set ID refers to a cell ID commonly used in a CoMP set.

In another example, the parameter transmitted in step S1102 may be values of u and v.

When a base sequence common in a CoMP set is generated, common u and v values are values commonly applied to a set including a plurality of cells to which the CoMP is applied, and the same value is configured for the plurality of cells to which the CoMP is applied. In the example of FIG. 7, CoMP is applied to cell A and cell B and common u and v are commonly signaled to cell A and cell B. The number of signaled bits may be, but is not limited to, a total of 6 including 5 bits for u value and 1 bit for v value. When a base sequence common in a CoMP set is generated, the base sequence is calculated by directly applying common u and v without using Equations 2 and 3.

When a UE-specific base sequence is generated, values of u and v are values applied to only a particular UE. The number of signaled bits may be, but is not limited to, a total of 6 including 5 bits for u value and 1 bit for v value. When a UE-specific base sequence is generated, the base sequence is calculated by directly applying u and v specific to a UE without using Equations 2 and 3.

When a transmission/reception point-specific base sequence is generated, values of u and v are values applied to only a UE transmitting a DM-RS to a particular transmission/reception point. The number of signaled bits may be, but is not limited to, a total of 6 including 5 bits for u value and 1 bit for v value. When a transmission/reception point-specific base sequence is generated, the base sequence is calculated by directly applying u and v specific to a transmission/reception point without using Equations 2 and 3 for calculating u and v.

In another example, the parameter transmitted in step S1102 may be Δss.

Δss for generating a base sequence common in a CoMP set will be referred to as a CoMP set Δss for discrimination from Δss specific to a serving cell. The number of signaled bits may be, but is not limited to, 5. When a base sequence common in a CoMP set is generated, a CoMP set Δss may be applied, instead of Δss of a serving cell, to Δss in Equation 2 for calculating u. The CoMP set Δss may have different values according to cells. For example, when a value of u calculated using a cell ID of a serving cell in cell A is 5 and a value of u calculated using a cell ID of a serving cell in cell B is 12, the CoMP set Δss in cell A may be configured to 15 and the CoMP set Δss in cell A may be configured to 8, so as to configure the value of common u for generating a base sequence common in a CoMP set to 20(=5+15=12++8).

Also, Δss for generating a UE-specific base sequence or a transmission/reception point-specific base sequence will be referred to as a UE-specific Δss or a transmission/reception point-specific Δss for discrimination from Δss specific to a serving cell. The number of signaled bits may be, but is not limited to, 5. When a UE-specific base sequence or a transmission/reception point-specific base sequence is generated, a UE-specific Δss or a transmission/reception point-specific Δss may be applied, instead of Δss of a serving cell, to Δss in Equation 2 for calculating u.

In an example, the indication information transmitted in step S1104 may be explicitly transferred 1 bit. For example, when the bit value is 0, a base sequence may be generated based on a parameter for generation of a base sequence of a serving cell to which the UE belongs. When the bit value is 1, a base sequence may be generated based on a parameter for generation of a UE-specific base sequence (or a transmission/reception point-specific base sequence) or a base sequence common in a CoMP set irrelative to the serving cell. As described above, the parameter for generation of the UE-specific base sequence (or the transmission/reception point-specific base sequence) or the common base sequence common in the CoMP set may be cell ID, u, v, or Δss. The explicit indication information may be included in an uplink grant and then transferred through a PDCCH.

Otherwise, when the bit value is 0, a base sequence may be generated based on a parameter for generation of a UE-specific base sequence (or a transmission/reception point-specific base sequence) or a base sequence common in a first CoMP set. When the bit value is 1, a base sequence may be generated based on a parameter for generation of a UE-specific base sequence (or a transmission/reception point-specific base sequence) or a base sequence common in a second CoMP set. This case can be implemented when a plurality of parameter sets for generation of a UE-specific base sequence (or a transmission/reception point-specific base sequence) or a common base sequence common in a CoMP set are transferred from a transmission/reception point to a UE.

In another example, the indication information transmitted in step S1104 may be implicitly transferred.

A value for indicating CS/OCC as shown in Table 1 may be used as an example of the implicit indication information. Referring to Table 1, the “cyclic shift field” for indicating CS/OCC may have 8 types of values. These values can be associated with 1 bit values for indicating a UE-specific base sequence (or a transmission/reception point-specific base sequence) or a common base sequence common in a CoMP set.

For example, among the 8 values of the “cyclic shift field”, four values may be values indicating generation of a cell-specific base sequence and the other four values may be values indicating generation of a UE-specific base sequence (or a transmission/reception point-specific base sequence) or a base sequence common in a CoMP set. Otherwise, six values may be values indicating generation of a cell-specific base sequence while the other two values may be values indicating generation of a UE-specific base sequence (or a transmission/reception point-specific base sequence) or a base sequence common in a CoMP set.

Table 2 below shows an example of indication information transferred together with CS/OCC.

TABLE 2

| Cyclic | | | | | | | | | |
|---|---|---|---|---|---|---|---|---|---|
| Shift Field | | | | | | | | | |
| in | | | | | | | | | 1 bit |
| uplink- | | | | | | | | | value |
| related DCI | n_{DMRS,λ}⁽²⁾ | | | | [w^{(λ)}(0) w^{(λ)}(1)] | | | | for base |
| format | λ = 0 | λ = 1 | λ = 2 | λ = 3 | λ = 0 | λ = 1 | λ = 2 | λ = 3 | sequence |
| 000 | 0 | 6 | 3 | 9 | [1 1] | [1 1] | [1 −1] | [1 −1] | 0 |
| 001 | 6 | 0 | 9 | 3 | [1 −1] | [1 −1] | [1 1] | [1 1] | 0 |
| 010 | 3 | 9 | 6 | 0 | [1 −1] | [1 −1] | [1 1] | [1 1] | 1 |
| 011 | 4 | 10 | 7 | 1 | [1 1] | [1 1] | [1 1] | [1 1] | 1 |
| 100 | 2 | 8 | 5 | 11 | [1 1] | [1 1] | [1 1] | [1 1] | 0 |
| 101 | 8 | 2 | 11 | 5 | [1 −1] | [1 −1] | [1 −1] | [1 −1] | 0 |
| 110 | 10 | 4 | 1 | 7 | [1 −1] | [1 −1] | [1 −1] | [1 −1] | 1 |
| 111 | 9 | 3 | 0 | 6 | [1 1] | [1 1] | [1 −1] | [1 −1] | 1 |

Table 2 shows four types of pairs in which the same OCC (or orthogonal sequence) value is applied to each layer, wherein one value in each pair is 0 as the 1 bit value and the other is 1. That is, the indication information (1 bit value for base sequence) either may be an explicit signal or may be transmitted to a UE in association with information for indicating an orthogonal sequence [w^{λ}(0) w^{λ}(1)] and a cyclic shift n_{DMRS,λ}⁽²⁾ of the reference signal.

For example, in the cases where the “cyclic shift field” has a value of 000 and a value of 111, the OCC has values of [+1 +1], [+1 +1], [+1 −1], and [+1 −1], which correspond to the same pair for each layer. Among these cases, the 1 bit value is configured to 0 in the case where the “cyclic shift field” has a value of 000 and to 1 in the case where the “cyclic shift field” has a value of 111. That is, a parameter for generation of a base sequence of a serving cell is employed when the “cyclic shift field” transmitted through DCI of a PDCCH has a value of 000, while a parameter for generation of a UE-specific base sequence (or a transmission/reception point-specific base sequence) or a base sequence common in a CoMP set is employed when the “cyclic shift field” has a value of 111.

By this method, one 1 bit value can be configured to 0 while the other 1 bit value is configured to 1 in each of a pair when the “cyclic shift field” has values of 001 and 010, a pair when the “cyclic shift field” has values of 011 and 100, and a pair when the “cyclic shift field” has values of 101 and 110.

Table 2 is only an example, and the eight types of values of the “cyclic shift field” can be associated with various types of 1 bit values for indicating a base sequence. The association scheme as described above may be defined in advance and previously known to the transmission/reception point and the UE in the system.

Meanwhile, when a resource to which a DM-RS transmitted by one UE is allocated overlaps a resource to which a DM-RS transmitted by another UE is allocated, it is possible to consider a scheme of allocating the DM-RS transmitted by the one UE to only a part of subcarriers instead of all the subcarriers in the resource to which the DM-RS transmitted by the one UE is allocated, so as to avoid interference between UEs. This scheme may be referred to as IFDMA (Interleaved FDMA).

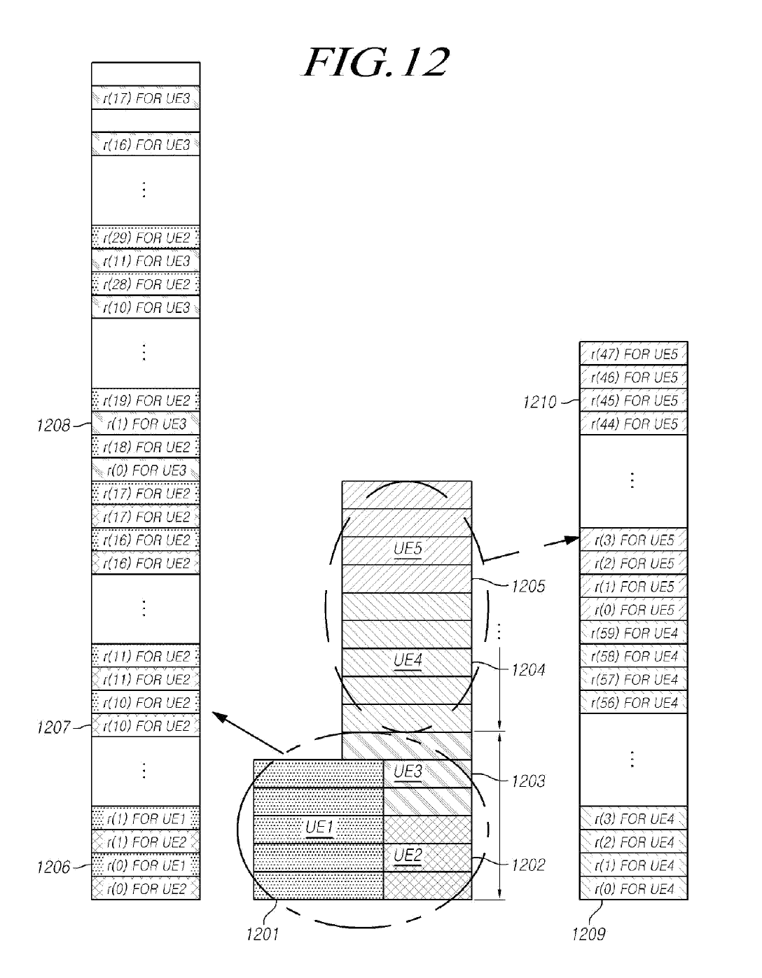

FIG. 12 is a diagram for describing an IFDMA scheme. Referring to FIG. 12, a resource block 1201 to which a DM-RS transmitted by UE (UE1) is allocated overlaps resource blocks 1202 and 1203 to which DM-RSs transmitted by UEs (UE2 and UE3) are allocated and does not overlap resource blocks 1204 and 1205 to which DM-RSs transmitted by UEs (UE4 and UE5) are allocated.

In this event, in the case of the resource blocks 1204 and 1205 which do not overlap the resource block 1201 to which the DM-RS transmitted by UE (UE1) is allocated, a DM-RS sequence may be allocated to all subcarriers 1209 and 1210 within the resource blocks.

Meanwhile, in the case of the resource blocks 1202 and 1203 which entirely or partially overlap the resource block 1201 to which the DM-RS transmitted by UE (UE1) is allocated, a DM-RS sequence may be allocated to only some subcarriers within the resource blocks. Referring to FIG. 12, a DM-RS sequence can be allocated to subcarriers 1206 having subcarrier indexes having a remainder of 1 (odd number) when the subcarrier indexes are divided by 2 in the case of UE1 and can be allocated to subcarriers 1207 and 1208 having subcarrier indexes having a remainder of 0 (even number) when the subcarrier indexes are divided by 2 in the case of UE2 and UE3.

An indication whether to the IFDMA scheme to a particular UE may be transmitted from a transmission/reception point to the UE through a separate signal. Otherwise, when information on a resource area to which the IFDMA scheme is applied is transferred to a UE and an uplink DM-RS resource of a particular UE overlaps its resource area, it is possible to configure application of the IFDMA scheme to the particular UE.

A combination of an indication whether the IFDMA scheme is applied and a value for indicating CS/OCC as shown in Table 1 may be used as an example of the implicit indication information. Referring to Table 1, the “cyclic shift field” for indicating CS/OCC have 8 types of values and the indication whether the IFDMA scheme is applied has two types of values, a total of 16 cases may occur. Among the 16 cases, some cases may be appointed to configuration of a cell-specific base sequence while the other cases are appointed to configuration of a UE-specific base sequence (or a transmission/reception point-specific base sequence) or a base sequence common in a CoMP set.

Table 3 below shows an example of indication information transferred together with CS/OCC and whether to apply IFDMA.

TABLE 3

| Cyclic Shift | | | | | | | | | | |
|---|---|---|---|---|---|---|---|---|---|---|
| Field in | | | | | | | | | on/off | 1 bit value |
| uplink-related | n_{DMRS,λ}⁽²⁾ | | | | [w^{λ}(0) w^{λ}(1)] | | | | for | for base |
| DCI format | λ = 0 | λ = 1 | λ = 2 | λ = 3 | λ = 0 | λ = 1 | λ = 2 | λ = 3 | IFDMA | sequence |
| 000 | 0 | 6 | 3 | 9 | [1 1] | [1 1] | [1 −1] | [1 −1] | off | 0 |
| | | | | | | | | | on | 0 |
| 001 | 6 | 0 | 9 | 3 | [1 −1] | [1 −1] | [1 1] | [1 1] | off | 0 |
| | | | | | | | | | on | 1 |
| 010 | 3 | 9 | 6 | 0 | [1 −1] | [1 −1] | [1 1] | [1 1] | off | 0 |
| | | | | | | | | | on | 1 |
| 011 | 4 | 10 | 7 | 1 | [1 1] | [1 1] | [1 1] | [1 1] | off | 0 |
| | | | | | | | | | on | 0 |
| 100 | 2 | 8 | 5 | 11 | [1 1] | [1 1] | [1 1] | [1 1] | off | 0 |
| | | | | | | | | | on | 0 |
| 101 | 8 | 2 | 11 | 5 | [1 −1] | [1 −1] | [1 −1] | [1 −1] | off | 0 |
| | | | | | | | | | on | 1 |
| 110 | 10 | 4 | 1 | 7 | [1 −1] | [1 −1] | [1 −1] | [1 −1] | off | 0 |
| | | | | | | | | | on | 1 |
| 111 | 9 | 3 | 0 | 6 | [1 1] | [1 1] | [1 −1] | [1 −1] | off | 0 |
| | | | | | | | | | on | 0 |

In Table 3, in the case where the OCC value of the first layer is [1 −1] and the IFDMA has been configured (the “cyclic shift field” has values of 001, 010, 101, and 101), the 1 bit value for indicating a UE-specific base sequence (or a transmission/reception point-specific base sequence) or a base sequence common in a CoMP set indicates 1. In the other cases, the 1 bit value for indicating a UE-specific base sequence (or a transmission/reception point-specific base sequence) or a base sequence common in a CoMP set indicates 0. That is, the indication information (1 bit value for base sequence) can be transmitted in association with first information (cyclic shift field in uplink-related DCI format) for indicating an orthogonal sequence [w^{λ}(0) w^{λ}(1)] and a cyclic shift n_{DMRS,λ}⁽²⁾ of the reference signal and second information (on/off for IFDMA) for appointing a subcarrier to which the reference signal is allocated.

Table 3 is only an example, and the 16 types of values of the combinations of the “cyclic shift field” and the indication on whether to apply the IFDMA scheme can be associated with various types of 1 bit values for indicating a base sequence. The association scheme as described above may be defined in advance and previously known to the transmission/reception point and the UE in the system.

As another example of implicit information, a start index of a Resource Block (RB) or a Resource Block Group (RBG) allocated for a DM-RS may be used. For example, when a result obtained by a modulo operation on a start index by a particular value A has a particular value B, the 1 bit value for indicating a UE-specific base sequence (or a transmission/reception point-specific base sequence) or a base sequence common in a CoMP set may indicate 1. In the other cases, the 1 bit value for indicating a UE-specific base sequence (or a transmission/reception point-specific base sequence) or a base sequence common in a CoMP set may indicate 0. The particular values A and B may be values either transmitted through signaling of a higher layer, such as RRC, or predefined in the system. The particular values A and B may be the same or different from each other, regardless of the entire system bandwidth and/or the bandwidth (or the number of resource blocks) allocated for a DM-RS. This can be expressed by Equation 5 below.

If (RB starting index for DM-RS) mod A=B, 1 bit value for base sequence=1.

Else, 1 bit value for base sequence=0. [Equation 5]

As described above, the particular value A for the modulo operation may be different according to the entire system bandwidth and/or the bandwidth allocated for a DM-RS. As an example, when the number of resource blocks corresponding to the bandwidth allocated for a DM-RS is N, A may be N×a (A=N×a). Here, a is a common value irrelative to the bandwidth allocated for a DM-RS may be configured in advance in the system. Otherwise, in consideration of the importance of the UE performing the CoMP among the entire UEs, a may be transmitted through signaling of a higher layer, such as RRC. That is, when the importance of the UE performing the CoMP is large, a may have a small value.

For example, among the cases where the particular value A is predefined or is a value transmitted through RRC, if A=2 and B=0, a UE-specific base sequence (or a transmission/reception point-specific base sequence) or a base sequence common in a CoMP set can be applied as the base sequence of a DM-RS to the case where a start index of a resource block allocated for the DM-RS has a remainder of 0 (even number) when the start index is divided by 2, and a cell-specific base sequence can be applied as the base sequence of the DM-RS to the case where the start index has a remainder of 1 (odd number).

As another example, among the cases where the particular value A is different according to the entire system bandwidth and/or a bandwidth allocated for a DM-RS, if a=3 and B=0, the particular value A is 6(=2×3) when the number of resource blocks corresponding to the bandwidth allocated for the DM-RS, a UE-specific base sequence (or a transmission/reception point-specific base sequence) or a base sequence common in a CoMP set can be applied as the base sequence of the DM-RS to the case where a start index of a resource block allocated for the DM-RS has a remainder of 0 when the start index is divided by 6, and a cell-specific base sequence can be applied as the base sequence of the DM-RS to the case where the remainder of the start index is not 0.

As another example of implicit indication information, “PHICH group number”, “PHICH sequence number”, or a combination thereof may be used. As noted from Equation 6 below, in an environment in which the “PHICH group number” and the “PHICH sequence number” are associated with the start point of a resource allocated for a DM-RS (or related PUSCH) and values of the “cyclic shift field” and use of the “PHICH group number” and the “PHICH sequence number” may apply a larger limit to scheduling of a transmission/reception point for CS/OCC allocation, there may be a limit in the PUSCH allocation, which may further apply a limit to the scheduling of the transmission/reception point. Then, it is possible to select the limit, which may compensatively occur in the implicit indication method for reducing overhead of DCI, such as a limit to the CS/OCC allocation, according to the system environment.

n_{PHICH}^{group}=(I_{PRB}_{_{—}}_{RA}+n_{DMRS})mod N_{PHICH}^{group}+I_{PHICH}N_{PHICH}^{group}

n_{PHICH}^{seq}=(└I_{PRB}_{_{—}}_{RA}/N_{PHICH}^{group}┘+n_{DMRS})mod 2N_{SF}^{PHICH} [Equation 6]

In Equation 6, n_{PHICH}^{group}, n_{PHICH}^{seq} are a PHICH group number and a PHICH sequence number, respectively, and I_{PRB}_{_{—}}_{RA} is an index of a first start Physical Resource Block (PRB) among PRBs allocated for a PUSCH. Also, nDMRS is a value indicated based on the “cyclic shift field” for indicating a CS/OCC, N_{PHICH}^{group} denotes the number of all PHICH groups, and n_{SF}^{PHICH} SF denotes the length of a spreading factor used for PHICH modulation. I_{PHICH} Moreover, has a value of 1 in a special case defined in TDD configuration 0 and a value of 0 in the other cases.

For example, a cell-specific base sequence may be applied to a base sequence of a DM-RS when the PHICH group number n_{PHICH}^{group} is an even number, and a UE-specific base sequence (or a transmission/reception point-specific base sequence) or a base sequence common in a CoMP set may be applied to the base sequence of the DM-RS when the PHICH group number is an odd number.

As another example, a cell-specific base sequence may be applied to a base sequence of a DM-RS when the PHICH sequence number n_{PHICH}^{seq} is an even number, and a UE-specific base sequence (or a transmission/reception point-specific base sequence) or a base sequence common in a CoMP set may be applied to the base sequence of the DM-RS when the PHICH sequence number is an odd number.

As another example, a UE-specific base sequence (or a transmission/reception point-specific base sequence) or a base sequence common in a CoMP set may be applied to the base sequence of the DM-RS when both the PHICH group number n_{PHICH}^{group} and the PHICH sequence number n_{PHICH}^{seq} are even numbers (or odd numbers), and a cell-specific base sequence may be applied to the base sequence of the DM-RS in the other cases.

As another example of implicit information, information indicating whether a UE performs CoMP may be used. When a UE knows that the UE itself performs CoMP through signaling information indicating whether the UE performs CoMP or implicitly knows that the UE itself performs CoMP in the system (non-transparent CoMP), the UE can determine a base sequence generation scheme of a DM-RS based on whether the UE performs CoMP. When the UE performs CoMP, a base sequence common in a CoMP set may be applied to a base sequence of a DM-RS. When the UE does not perform CoMP, a cell-specific base sequence may be applied to a base sequence of a DM-RS.

In other words, UEs performing CoMP in a CoMP set have the same base sequence even when they belong to different serving cells, and UEs not performing CoMP may have different base sequences based on serving cells to which they belongs.

Otherwise, a cell-specific base sequence may be applied to a base sequence of a DM-RS when a UE does not perform CoMP, and a UE-specific base sequence (or a transmission/reception point-specific base sequence) or a base sequence common in a CoMP set may be applied to the base sequence of the DM-RS when the UE performs CoMP.

While the technical spirit of the present invention has been exemplarily described, it will be understood by a person skilled in the art that the present invention may be changed and modified in various forms without departing from the scope of the present invention. Accordingly, the embodiments disclosed in the present invention are only for describing, but not limiting, the technical idea of the present invention, and the scope of the technical idea of the present invention is not limited by the embodiments. The scope of the present invention shall be construed on the basis of the accompanying claims in such a manner that all of the technical ideas included within the scope equivalent to the claims belong to the present invention.

1. A transmission/reception point comprising:
a parameter transmission unit to generate a parameter for generation of a second base sequence different from a first base sequence specific to a serving cell, to which a User Equipment (UE) belongs, as a base sequence for an uplink reference signal and transmit the generated parameter to the UE; and
an indication information transmission unit to transmit indication information on whether to use the first base sequence or the second base sequence in order to generate the base sequence, to the UE.

2. The transmission/reception point of claim 1, wherein the parameter comprises one of a virtual cell identifier (ID), a sequence-group number and base sequence number, and an offset added to a value calculated based on the cell ID in order to calculate the sequence-group number.

3. The transmission/reception point of claim 1, wherein the indication information is transmitted in association with information for indicating a cyclic shift and an orthogonal sequence of the reference signal.

4. A method of configuring a reference signal by a transmission/reception point, the method comprising:
generating a parameter for generation of a second base sequence different from a first base sequence specific to a serving cell, to which a User Equipment (UE) belongs, as a base sequence for an uplink reference signal, and transmitting the generated parameter to the UE; and
transmitting indication information on whether to use the first base sequence or the second base sequence in order to generate the base sequence, to the UE.

5. The method of claim 4, wherein the parameter comprises one of a virtual cell identifier (ID), a sequence-group number and base sequence number, and an offset added to a value calculated based on the cell ID in order to calculate the sequence-group number.

6. The method of claim 4, wherein the indication information is transmitted in association with information for indicating a cyclic shift and an orthogonal sequence of the reference signal.

7. A User Equipment (UE) comprising:
a parameter reception unit to receive a parameter for generation of a second base sequence different from a first base sequence specific to a serving cell, to which the UE belongs, as a base sequence for an uplink reference signal;
an indication information reception unit to receive indication information on whether to use the first base sequence or the second base sequence in order to generate the base sequence; and
a reference signal transmission unit to generate a base sequence specific to the serving cell when the indication information indicates the first base sequence, generate a base sequence based on the parameter when the indication information indicates the second base sequence, and generate and transmit a reference signal based on a generated base sequence.

8. The UE of claim 7, wherein the parameter comprises one of a virtual cell identifier (ID), a sequence-group number and base sequence number, and an offset added to a value calculated based on the cell ID in order to calculate the sequence-group number.

9. The UE of claim 7, wherein the indication information is transmitted in association with information for indicating a cyclic shift and an orthogonal sequence of the reference signal.

10. A method of transmitting a reference signal by a User Equipment (UE), the method comprising:
receiving a parameter for generation of a second base sequence different from a first base sequence specific to a serving cell, to which the UE belongs, as a base sequence for an uplink reference signal;
receiving indication information on whether to use the first base sequence or the second base sequence in order to generate the base sequence; and
generating a base sequence specific to the serving cell when the indication information indicates the first base sequence, generating a base sequence based on the parameter when the indication information indicates the second base sequence, and generating and transmitting a reference signal based on a generated base sequence.

11. The method of claim 10, wherein the parameter comprises one of a virtual cell identifier (ID), a sequence-group number and base sequence number, and an offset added to a value calculated based on the cell ID in order to calculate the sequence-group number.

12. The method of claim 10, wherein the indication information is transmitted in association with information for indicating a cyclic shift and an orthogonal sequence of the reference signal.
